(19) United States
(12) Patent Application Publication
(10) Pub. No.: US 2010/0332844 A1
(43) Pub. Date: Dec. 30, 2010

(54) MAGNETIC DISK DEVICE AND COMMAND EXECUTION METHOD FOR MAGNETIC DISK DEVICE

(75) Inventor: Daisuke KOBAYASHI, Oume-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/791,679

(22) Filed: Jun. 1, 2010

(30) Foreign Application Priority Data
Jun. 29, 2009 (JP) 2009-154375

(51) Int. Cl. G06F 12/14

(52) U.S. Cl. 713/189

(57) ABSTRACT

According to one embodiment, a magnetic disk device includes a receiver, an encrypting-and-decrypting module, a read-and-write controller, a setting module, an order controller, an executing module. The receiver receives a command to write data to or read data from a recording medium segmented into a plurality of storage areas each corresponding to an encryption key. The command causes an access to at least one of the storage areas. The encrypting-and-decrypting module encrypts the data or decrypts the data using the encryption key. The read-and-write controller controls writing the data to the recording medium and reading data therefrom. The setting module sets the encryption key corresponding to the storage area accessed by the command to the encrypting-and-decrypting module. The order controller controls the execution order in which commands are executed and brings up the execution order of the command causing an access to the storage area. The executing module executes the commands in the execution order.

### CROSS-REFERENCE TO RELATED APPLICATIONS

This application is based upon and claims the benefit of priority from Japanese Patent Application No. 2009-154375, filed Jun. 29, 2009, the entire contents of which are incorporated herein by reference.

### BACKGROUND

1. Field

One embodiment of the invention relates to a magnetic disk device and a command execution method for the magnetic disk device.

2. Description of the Related Art

In recent years, there has been an increasing need for a magnetic disk device having advanced security features, and magnetic disk devices that encrypt data to be recorded on a recording medium such as a magnetic disk are manufactured. Such a magnetic disk device encrypts and decrypts data to be recorded on the magnetic disk using a single encryption key. For example, Japanese Patent Application Publication (KOKAI) No. 2004-201038 discloses a conventional magnetic disk device having more advanced security features. The conventional magnetic disk device generates a plurality of encryption keys from a plurality of pieces of personal identification information. The conventional magnetic disk device divides data in the magnetic disk device into a plurality of storage areas, and encrypts/decrypts the data in each of the storage areas using corresponding one of the encryption keys. Upon encrypting and decrypting data, a magnetic disk device having such an encryption feature sets an encryption key to an encrypting/decrypting circuit to perform encryption and decryption. In other words, by setting an encryption key to the encrypting/decrypting circuit, it becomes possible to encrypt data to be recorded on the magnetic disk and to decrypt data recorded on the magnetic disk.

In the magnetic disk device in which a single encryption key is set, because the same encryption key can be used for accessing every data on the magnetic disk, it is not necessary to change the encryption key set to the encrypting/decrypting circuit. However, in the magnetic disk device in which a plurality of encryption keys can be set as described above, if it becomes necessary to access a storage area managed by an encryption key different from the one currently set in the encrypting/decrypting circuit, the encryption key has to be reset to the encrypting/decrypting circuit. To set the encryption key to the encrypting/decrypting circuit, the time corresponding to several tens of magnetic disk revolutions is required. Conventional techniques for reordering the execution order of commands do not take into account the time required to change the setting of the encryption key (resetting time). Therefore, in a magnetic disk device where a plurality of encryption keys can be set, if the execution order of commands is reordered using the conventional techniques, a change in the encryption key setting may occur frequently, which may increase the time taken for encryption key reset and reduce the processing performance.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a hard disk drive (HDD) according to a first embodiment of the invention;

FIG. 2 is an exemplary schematic diagram of a queue buffer that stores commands issued by a host system and received by a hard disk controller (HDC) in the first embodiment;

FIG. 3 is an exemplary flowchart of a reordering process performed by a conventional magnetic disk device;

FIG. 4 is an exemplary flowchart of a reordering process performed by the HDD in the first embodiment;

FIG. 5 is an exemplary flowchart of a reordering process performed by an HDD according to a second embodiment of the invention;

FIG. 6 is an exemplary flowchart of a reordering process performed by an HDD according to a third embodiment of the invention;

FIG. 7 is an exemplary conceptual diagram of queued commands stored in a queue buffer before a reordering process and encryption keys that need to be set during the execution thereof according to a fourth embodiment of the invention;

FIG. 8 is an exemplary conceptual diagram of the queued commands stored in the queue buffer and the encryption keys that need to be set during the execution thereof, and the execution order thereof in the fourth embodiment;

FIG. 9 is an exemplary conceptual diagram of queued commands stored in a queue buffer before a reordering process and encryption keys that need to be set during the execution thereof according to a fifth embodiment of the invention; and

FIG. 10 is an exemplary conceptual diagram of the queued commands stored in the queue buffer and the encryption keys that need to be set during the execution thereof, and the execution order thereof in the fifth embodiment.

### DETAILED DESCRIPTION

Various embodiments according to the invention will be described hereinafter with reference to the accompanying drawings. In general, according to one embodiment of the invention, a magnetic disk device comprises a receiver, an encrypting-and-decrypting module, a read-and-write controller, a setting module, an order controller, an executing module. The receiver is configured to receive a command from an information processor. The command instructs to write data to or read data from a recording medium that is segmented into a plurality of storage areas each corresponding to an encryption key generated from identification information that identifies a user and causes an access to at least one of the storage areas. The encrypting-and-decrypting module is configured to encrypt the data that the command instructs to write or decrypt the data that is encrypted and that the command instructs to read using the encryption key. The read-and-write controller is configured to control writing the data encrypted by the encrypting-and-decrypting module to the recording medium and reading data from the recording medium. The setting module is configured to set the encryption key corresponding to the storage area accessed by the command to the encrypting-and-decrypting module according to execution of the command. The order controller is configured to control the execution order in which commands are executed and bring up the execution order of the command causing an access to the storage area corresponding to the encryption key set to the encrypting-and-decrypting module among the commands yet to be executed. The executing module is configured to execute the commands in the execution order.

According to another embodiment of the invention, a command execution method for a magnetic disk device comprises: a receiver receiving a command from an information processor, the command instructing to write data to or read data from a recording medium that is segmented into a plurality of storage areas each corresponding to an encryption key generated from identification information that identifies a user and causing an access to at least one of the storage areas; an encrypting-and-decrypting module encrypting the data that the command instructs to write or decrypting the data that is encrypted and that the command instructs to read using the encryption key; a read-and-write controller controlling writing the data encrypted by the encrypting-and-decrypting module to the recording medium and reading data from the recording medium; a setting module setting the encryption key corresponding to the storage area accessed by the command to the encrypting-and-decrypting module according to execution of the command; an order controller controlling an execution order in which commands are executed and bringing up the execution order of the command causing an access to the storage area corresponding to the encryption key set to the encrypting-and-decrypting module among the commands yet to be executed; and an executing module executing the commands in the execution order.

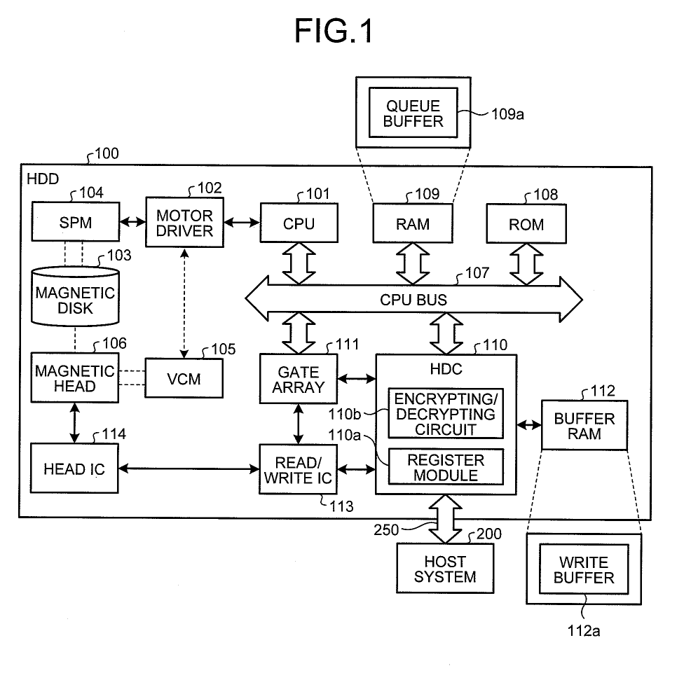

FIG. 1 is a block diagram of a hard disk drive (HDD) as a magnetic disk device according to a first embodiment of the invention. As illustrated in FIG. 1, a HDD 100 comprises a central processing unit (CPU) 101, a motor driver (voice coil motor (VCM)/spindle motor (SPM) driver) 102, a magnetic disk 103, an SPM 104, a VCM 105, a magnetic head 106, a CPU bus 107, a read-only memory (ROM) 108, a random access memory (RAM) 109, a hard disk controller (HDC) 110, a gate array 111, a buffer RAM 112, a read/write integrated circuit (IC) 113, and a head IC 114.

The ROM 108 stores various data and various programs executed by the CPU 101. The RAM 109 temporarily stores the various data and the various programs, and provides a work area for the CPU 101 and a parameter area for storing parameters. The CPU 101 is a processor functioning as a main controller that loads the various programs stored in the ROM 108 into the RAM 109 and executes them to control the overall operation of the HDD 100 and the motor driver (VCM/SPM driver) 102 in a time-division manner. Under the control of the CPU 101, the motor driver 102 supplies currents, for driving the SPM 104 that rotates the magnetic disk 103 steadily and for driving the VCM 105 that moves the magnetic head 106 to a target position, to the SPM 104 and the VCM 105. The HDC 110 communicates with a host system 200 via an interface bus 250, and receives a command issued by and transmitted from the host system 200. In the first embodiment, the command gives an instruction to write data to the magnetic disk 103 or to read data from the magnetic disk 103 and transmit the data. The execution of such a command involves an access to the magnetic disk 103. In response to the command, the HDC 110 receives data (write data) that is instructed to be written to the magnetic disk 103 from the host system 200, or transmits data (read data) that is instructed to be read from the magnetic disk 103 and transmitted to the host system 200. The gate array 111 functions as a control-signal generating circuit that generates various signals that are required for the control in the HDD 100. The CPU 101, the ROM 108, the RAM 109, the HDC 110, and the gate array 111 are connected to the CPU bus 107. The RAM 109 may be built in the CPU 101 to allow the CPU 101 to access the RAM 109 directly and independently from the CPU bus 107.

A part of the storage area in the RAM 109 is used as an area for a queue buffer (a queue buffering buffer and a queue buffer table) 109a. The queue buffer 109a is used to store a command transmitted from the host system 200 that uses the HDD 100 for a period until the command is executed. In the first embodiment, the order of the commands in the queue buffer 109a is initially set to the order in which the commands are received. The order is changed as appropriate by a reordering process, described later. The CPU 101 then executes the commands from the one at the top in the queue buffer 109a.

Data is written to or read from the magnetic disk 103 via the HDC 110 under the control of the CPU 101. The magnetic disk 103 is segmented into a plurality of storage areas. Each of the storage areas corresponds to each encryption key encrypted with personal identification information for identifying a use, described later. In the first embodiment, data encrypted using a corresponding encryption key is written to the storage area, and the data read from the storage area can be decrypted using the encryption key corresponding to the storage area. For example, the corresponding relationship between each of the storage areas and each of the encryption keys may be written to the magnetic disk 103 in a form of a table, or the HDC 110 may comprise a storage circuit and such a corresponding relationship may be stored therein.

The HDC 110 comprises a register module 110a and an encrypting/decrypting circuit 110b. The register module 110a comprises a set of controlling registers. The encrypting/decrypting circuit 110b uses the encryption keys, described later, set by the CPU 101 to encrypt data (write data) that a command instructs to write to the magnetic disk 103, or decrypts data (read data) that is encrypted and that a command instructs to read from the magnetic disk 103 and transmit. The gate array 111 also comprises a register module (not illustrated) that has a set of controlling registers as with the HDC 110. Each of the controlling registers is assigned to a part of an area in the address space in the CPU 101. The CPU 101 performs a read/write from/to an area to which the controlling register is assigned to control the corresponding HDC 110 or the gate array 111. The HDC 110 is connected to the gate array 111, the buffer RAM 112, and the read/write IC 113, in addition to the CPU bus 107.

The buffer RAM 112 is a buffer memory constituted by the RAM 109. A part of the storage area in the buffer RAM 112 is used as an area for a write buffer 112a that temporarily stores write data transmitted from the host system 200. Another part of the storage area in the buffer RAM 112 is used as an area for a read buffer that temporarily stores read data. The write buffer 112a and the read buffer are used as, for example, a ring buffer.

The head IC 114 amplifies a signal read by the magnetic head 106 (read analog signal), and outputs the amplified signal to the read/write IC 113. The head IC 114 also controls the magnetic head 106 to cause the magnetic head 106 to write a write signal, output from the read/write IC 113, to the magnetic disk 103. The magnetic head 106 generates a magnetic field to magnetize the magnetic body to write the write signal to the magnetic disk 103. The magnetic head 106 also detects a change in the magnetic field to read data written to the magnetic disk 103 as a signal. The read/write IC 113 performs an analog-to-digital (A/D) conversion to encode the read signal amplified by the head IC 114 and outputs the encoded signal to the HDC 110, and pulses and outputs the read signal to the gate array 111. The read/write IC 113 also encodes data encrypted by the HDC 110 to convert the data to a write signal, and outputs the write signal to the head IC 114 according to each control signal received from the gate array 111.

Upon reading data in the HDD 100, data (read data) recorded on the magnetic disk 103 is read by the magnetic head 106. The signal read by the magnetic head 106 (read analog signal) is amplified by the head IC 114, A/D converted to become encoded by the read/write IC 113, and output to the HDC 110. The read signal amplified by the head IC 114 is also pulsed by the read/write IC 113, and output to the gate array 111. The gate array 111 generates various timing signals from the pulse (read pulse) output from the read/write IC 113. The HDC 110 processes the read data encoded by the read/write IC 113 according to each control signal received from the gate array 111. Such processes include decryption of the read data performed by the encrypting/decrypting circuit 110b. By performing such processes, the HDC 110 generates read data to be transmitted to the host system 200. The read data is once stored in the buffer RAM 112, and transferred to the host system 200 via the interface bus 250.

On the contrary, upon writing data to the HDD 100, the write data transmitted from the host system 200 to the HDD 100 via the interface bus 250 is received by the HDC 110, and stored once in the buffer RAM 112. The write data stored in the buffer RAM 112 is encoded by the HDC 110 according to each control signal received from the gate array 111, encrypted by the encrypting/decrypting circuit 110b using the encryption key, converted into a write signal by the read/write IC 113, and written to the magnetic disk 103 by the magnetic head 106 via the head IC 114.

The encryption key used for encrypting and decrypting data will now be explained. The encryption key is generated by the CPU 101 converting, for example, the personal identification information for authenticating the user using an encryption function or a one-way function. The CPU 101 obtains the personal identification information of the user, for example, upon authenticating the user. More specifically, upon authenticating the user, the CPU 101 requests the user to enter the personal identification information. When the personal identification information is entered via an operation input module (not illustrated), the encryption key is generated with the information and input to the encrypting/decrypting circuit 110b. In this manner, the encryption key is set to the encrypting/decrypting circuit 110b. How the user is authenticated is not particularly limited.

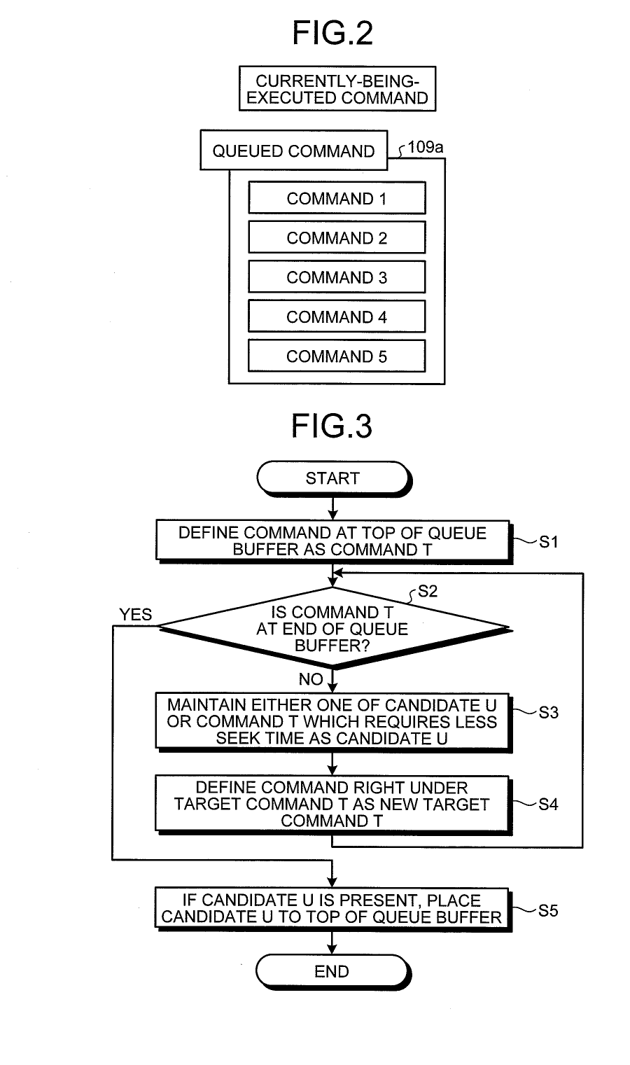

The reordering process to reorder the execution order of commands will now be explained. FIG. 2 is a schematic diagram of the queue buffer 109a that stores commands issued by the host system 200 and received by the HDC 110. FIG. 2 illustrates an example of a command that actually causes an access to the magnetic disk 103 (hereinafter, “currently-being-executed command”), and five queued commands that are yet to be executed and waiting to be executed. The commands are initially queued in the order in which they are received before the reordering process is performed. Upon executing the commands, the CPU 101 calculates the position of the magnetic disk 103 to which the command to be executed is to make an access, and controls the VCM 105 to perform a seek process to move the magnetic head 106 to the position. While the CPU 101 is performing the seek process, no access is made to the magnetic disk 103. That is, the longer the time (seek time) is required for the seek process, the further the processing performance of the magnetic disk device degrades. In view of this, a magnetic disk device performs the reordering process to reorder the execution order of the commands.

The reordering process performed by a conventional magnetic disk device will now be explained referring to FIG. 3. The magnetic disk device defines the queued command at the top of the queue buffer as a command T (S1). The magnetic disk device determines whether the command T is at the end of the queue buffer (S2). If not (No at S2), the magnetic disk device defines one of the queued commands excluding the command T stored in the queue buffer as a candidate command U, and further defines either one of the command T and the command U with a shorter seek time as the candidate command U (S3). The magnetic disk device defines the queued command right under the command T as a new command T (S4). Then, the process returns to S2. If the command T is at the end of the queue buffer (Yes at S2), the magnetic disk device places the candidate command U to the top (head) of the queue buffer (S5). In this manner, by allowing the magnetic disk device to execute the command whose seek time is calculated to be the shortest among the commands, the entire seek time is reduced to improve the processing performance of the magnetic disk device.

In the first embodiment, because the HDD 100 is capable of setting a plurality of encryption keys, when a command causes an access to a position in a different storage area in the magnetic disk 103, it is necessary to change the encryption key set to the encrypting/decrypting circuit 110b. The expected seek time for accessing a predetermined position in the magnetic disk 103 is approximately 6×10−3 seconds if the process of changing the encryption key setting (hereinafter, “encryption key reset”) is not performed. If the encryption key reset is performed, several ten times of the time is required. Because the reordering process in the conventional magnetic disk device does not take into account a change in the encryption key setting, if accesses are constantly made to different storage areas in the magnetic disk 103 where the encryption key reset needs to be performed frequently, the rotational delay of the magnetic disk 103, i.e., rotational latency, increases, resulting in substantial degradation of the processing performance of the HDD 100. To avoid this, in the first embodiment, if a plurality of commands issued by the host system 200 and received by the HDC 110 are stored in the queue buffer 109a, the CPU 101 in the HDD 100 analyzes the commands. The CPU 101 reorders the execution order of the commands as appropriate by bringing up the execution order of a command that causes an access to a storage area corresponding to the encryption key set to the encrypting/decrypting circuit 110b.

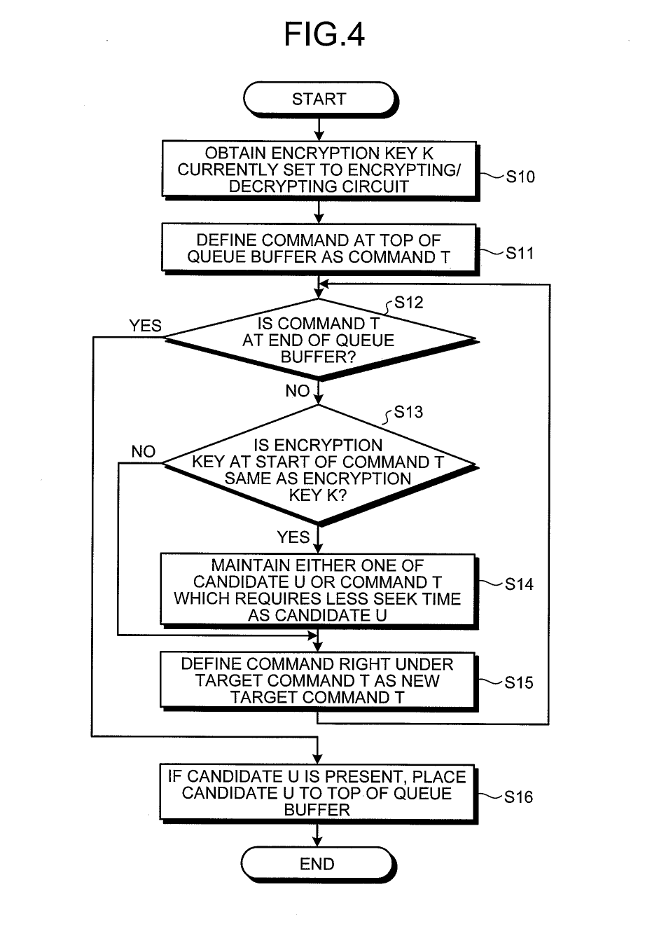

A reordering process performed by the HDD 100 according to the first embodiment will now be explained referring to FIG. 4. The CPU 101 in the HDD 100 obtains the encryption key K set to the encrypting/decrypting circuit 110b (S10). The CPU 101 defines the queued command at the top of the queue buffer 109a as a command T (S11), and determines whether the command T is at the end of the queue buffer 109a (S12). If not (no at S12), the CPU 101 analyzes the command T, and determines whether the position of the magnetic disk 103 accessed at the start of execution of the command T is in the storage area corresponding to the encryption key K obtained at S10 (S13). If the position is in the storage area corresponding to the encryption key K (Yes at S13), the CPU 101 defines one of the queued commands excluding the command T stored in the queue buffer 109a as the candidate command U. The CPU 101 also defines either one of the command T or the candidate command U with shorter seek time as the candidate command U (S14), and defines the queued command right under the command T as a new command T (S15). Then, the process returns to S12. If the position is not in the storage area corresponding to the encryption key K (No at S13), the process proceeds to S15. If the command T is at the end of the queue buffer 109a (Yes at S12), the CPU 101 places the candidate command U to the top (head) of the queue buffer (S16).

As described above, according to the first embodiment, the execution order of a command that causes an access to a position in a storage area corresponding to an encryption key set to the encrypting/decrypting circuit 110b at the start of the execution thereof is brought up. This brings up the execution order of the command that can be executed without changing the setting of the encryption key in the encrypting/decrypting circuit 110b, and brings down the execution order of those requiring a change in the encryption key setting. In other words, commands that cause an access to the same storage area among the segmented storage areas for the encryption keys, respectively, are executed consecutively. In this manner, the number of times of the encryption key reset can be reduced, which reduces the encryption key reset time. As a result, the entire processing time can be reduced, and the processing performance of the HDD 100 can be improved.

A magnetic disk device according to a second embodiment of the invention will now be explained. Constituent elements corresponding to those of the first embodiment will be designated by the same reference numerals, and their description will not be repeated.

Some commands require the encryption key reset because the target of an access changes to a different storage area, e.g., the command accesses the storage areas across the boundary during the execution thereof. While executing such a command, upon performing the reordering process, if the CPU 101 changes the execution order of the queued commands based on the encryption key that is currently set to the encrypting/decrypting circuit 110b in the manner described above in the first embodiment, the commands causing an access to the same storage area may not be executed consecutively. In response, in the second embodiment, when a currently-being-executed command is present and a plurality of such queued commands are stored in the queue buffer 109a, in the reordering process, the CPU 101 brings up the execution order of the queued command causing an access to the storage area corresponding to the encryption key that is expected to be set in the encrypting/decrypting circuit 110b when the currently-being-executed command is completed.

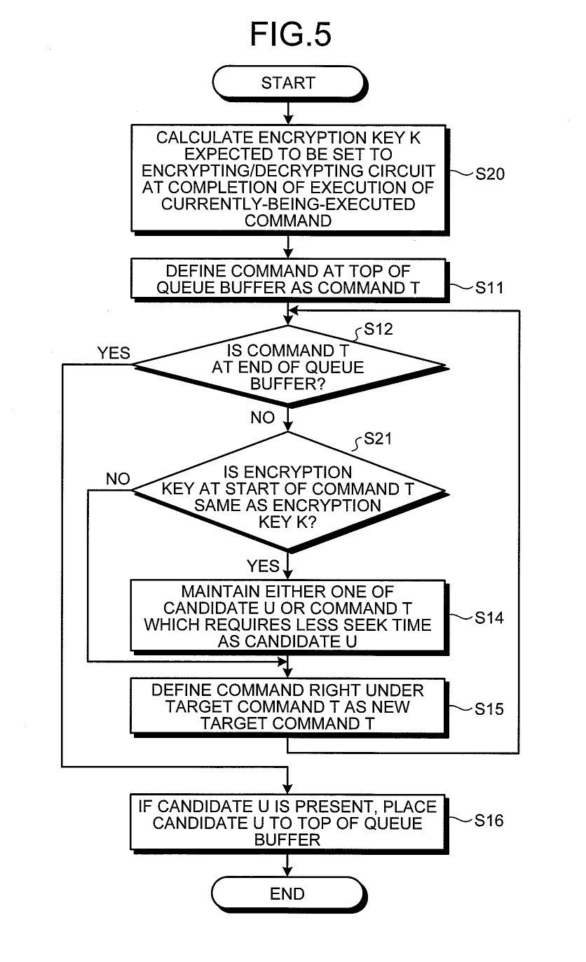

A reordering process performed by the HDD 100 according to the second embodiment will now be explained referring to FIG. 5. The CPU 101 in the HDD 100 analyzes the currently-being-executed command, and calculates the encryption key K that is expected to be set to the encrypting/decrypting circuit 110b when the execution of the currently-being-executed command is completed (S20). The process at S11 and S12 is the same as previously described in the first embodiment. The CPU 101 analyzes the command T to determine whether the position of the magnetic disk 103 to be accessed at the start of execution of the command T is in the storage area corresponding to the encryption key K calculated at S20 (S21). If the position is in the storage area corresponding to the encryption key K (Yes at S21), the process proceeds to S14. If not (No at S21), the process proceeds to S15. The process at S14 to S16 is the same as previously described in the first embodiment.

With this, even if the target of an access changes to a different storage area during the execution of a single command, by bringing up the execution order of the queued command causing an access to the same storage area accessed right before the execution of the currently-being-executed command is completed, commands causing an access to the same storage area can be executed consecutively, and the processing performance of the HDD 100 can be improved more effectively. In other words, even if the encryption key reset becomes necessary while a single command is executed, by bringing up the execution order of a command that can be executed without changing the encryption key set in the encrypting/decrypting circuit 110b upon completion of the execution of the currently-being-executed command, the number of times the encryption key reset is performed can be reduced effectively, and the encryption key reset time can be reduced effectively, without performing the encryption key reset wastefully. As a result, the entire processing time can be reduced, to improve the processing performance of the HDD 100 more effectively.

A magnetic disk device according to a third embodiment of the invention will now be explained. Constituent elements corresponding to those of the first and the second embodiments will be designated by the same reference numerals, and their description will not be repeated.

In the second embodiment, a command that requires a change in the encryption key setting (encryption key reset) during the execution thereof is explained. Such a command requires a longer processing time as a whole compared with a command that does not require the encryption key reset. Therefore, in the third embodiment, when a currently-being-executed command is present and a plurality of queued commands are stored in the queue buffer 109a, in the reordering process, the CPU 101 brings up the execution order of an queued command that does not require any change in the encryption key setting during the execution thereof among the queued commands.

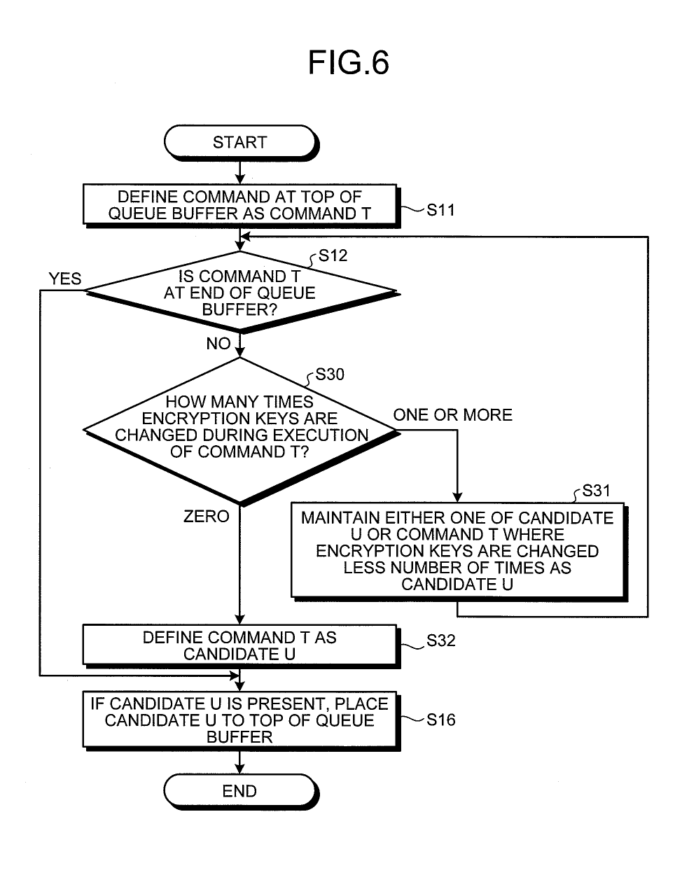

A reordering process performed by the HDD 100 according to the third embodiment will now be explained referring to FIG. 6. The process at S11 and S12 is the same as previously described in the first embodiment. The CPU 101 in the HDD 100 analyzes the command T to determine the number of times the accessed storage areas changes in the magnetic disk 103 during the execution of the command T, i.e., the number of times the encryption key setting is required to be changed during the execution of the command T (S30). As a result of the determination at S30, if no change of the encryption key setting is required during the execution of the command T (ZERO at S30), the process proceeds to S32. The CPU 101 defines the command T as the candidate command U (S32), and the process proceeds to S16. The process at S16 is the same as previously described in the first embodiment. As a result, the execution order of a command that does not require any change in the encryption key setting during the execution thereof is brought up. On the contrary, as a result of the determination at S30, if the change in the encryption key setting is required equal to or more than one time during the execution of the command T (ONE OR MORE at S30), the process proceeds to S31. The CPU 101 defines a queued command excluding the command T stored in the queue buffer 109a as the candidate command U, and further defines either one of the command T or the command U, which requires a change in the encryption key setting less number of times, as the candidate command U (S31). Then, the process proceeds to S12.

With this, because the execution order of a command that does not require any change in the encryption key setting during the execution thereof can be brought up, the number of times the encryption key reset is performed can be reduced, which reduces the encryption key reset time. As a result, the overall processing time can be reduced to improve the processing performance of the HDD 100.

A magnetic disk device according to a fourth embodiment of the invention will now be explained. Constituent elements corresponding to those of the first to the third embodiments will be designated by the same reference numerals, and their description will not be repeated.

The fourth embodiment corresponds to a combination of the second and the third embodiment. In other words, when a currently-being-executed command is present and a plurality of queued commands are stored in the queue buffer 109a, in the reordering process, the CPU 101 brings up the execution order of queued commands that cause an access to the storage area corresponding to the encryption key that is set in the encrypting/decrypting circuit 110b upon completion of the execution of the currently-being-executed command to a higher execution order from those that require a change in the encryption key setting less number of times during the execution thereof.

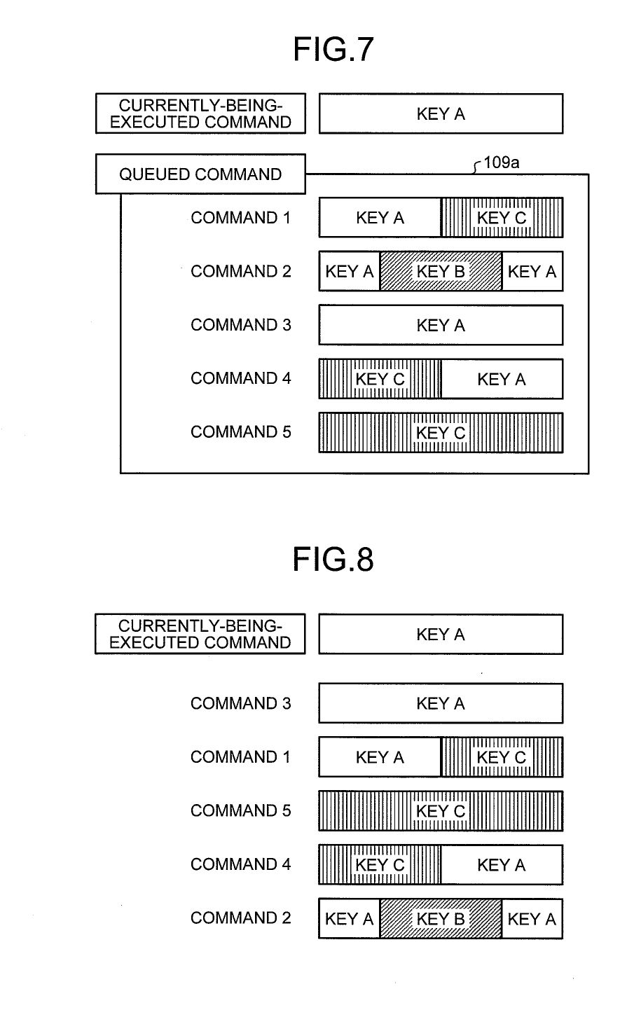

FIG. 7 conceptually illustrates the queued commands stored in the queue buffer 109a before the reordering process, and the encryption keys that need to be set during the execution thereof. FIG. 8 conceptually illustrates the queued commands stored in the queue buffer 109a and the encryption keys that need to be set during the execution thereof, and the execution order thereof. As illustrated in FIGS. 7 and 8, according to the fourth embodiment, a command 3, a command 1, a command 5, a command 4, and a command 2 are executed in this order. Among the commands that cause an access to the storage area corresponding to the encryption key set in the encrypting/decrypting circuit 110b upon completion of execution of the currently-being-executed command, a command that requires a change in the encryption key setting zero times during the execution thereof, i.e., a command that does not require any change in the encryption key setting during the execution thereof (in this example, the command 3), is most prioritized. Therefore, among the queued commands that cause an access to the storage area corresponding to the same encryption key as that set in the encrypting/decrypting circuit 110b upon completion of execution of the currently-being-executed command, those that require a change in the encryption key setting less number of times are executed at a higher priority.

In other words, with the scheme described above, the commands that cause an access to the same storage area can be executed consecutively, and in addition, a command that requires a change in the encryption key setting less number of times are executed at a higher priority. As a result, the number of times the encryption key reset is performed can be reduced effectively, and the encryption key reset time can be reduced without performing the encryption key reset wastefully. As a result, the overall processing time can be reduced to improve the processing performance of the HDD 100 more effectively.

A magnetic disk device according to a fifth embodiment of the invention will now be explained. Constituent elements corresponding to those of the first to the fourth embodiments will be designated by the same reference numerals, and their description will not be repeated.

In the fifth embodiment, when a plurality of queued commands are stored in the queue buffer 109a, in the reordering process, the CPU 101 divides a command every time the accessed storage area is changed during the execution thereof, i.e., every time a different encryption key needs to be set during the execution thereof. Each of the divided commands becomes an queued command. The CPU 101 then performs the reordering process for each of the queued commands in the manner described above in connection with FIG. 4 in the first embodiment. Such a scheme can be applied to a command (write command) in which write data has been received from the host system 200 and a receipt completion acknowledgement has been returned to the host system 200 but the write data is still maintained.

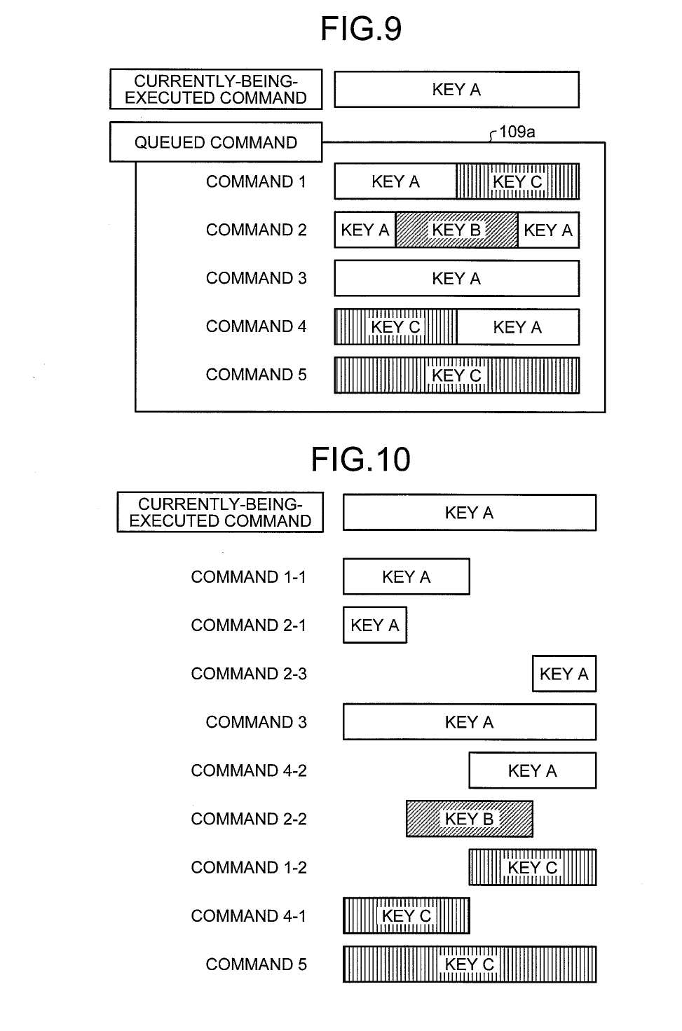

FIG. 9 conceptually illustrates the queued commands stored in the queue buffer 109a before the reordering process and the encryption keys that need to be set during the execution thereof. FIG. 10 conceptually illustrates the queued commands stored in the queue buffer 109a and the encryption keys that need to be set during the execution thereof, and the execution order thereof. As illustrated in FIGS. 9 and 10, according to the fifth embodiment, the command 1 is divided into commands 1-1 and 1-2. The command 2 is divided into commands 2-1, 2-2, and 2-3. The command 4 is divided into commands 4-1 and 4-2. Because the commands 3 and 5 do not require any change in the encryption key setting during the execution thereof, the commands 3 and 5 are not divided. Thus, the command 1-1, the command 2-1, the command 2-3, the command 3, the command 4-2, the command 2-2, the command 1-2, the command 4-1, and the command 5 are executed in this order. In such a case, while the commands 1 to 5 are being executed, encryption key setting is changed only once.

In other words, because the commands causing an access to the same storage area are executed consecutively, the number of times the encryption key reset is performed can be reduced effectively, which reduces the encryption key reset time effectively. As a result, the overall processing time can be reduced to improve the processing performance of the HDD 100 more effectively.

A magnetic disk device according to a sixth embodiment of the invention will now be explained. Constituent elements corresponding to those of the first to the fifth embodiments will be designated by the same reference numerals, and their description will not be repeated.

In the sixth embodiment, when a plurality of queued commands are stored in the queue buffer 109a and each of the queued commands causes an access to a position in a storage area corresponding to an encryption key that is different from the one set in the encrypting/decrypting circuit 110b, the CPU 101 waits for a predetermined time until the host system 200 issues and transmits a command. Upon obtaining the command issued by and transmitted from the host system 200 subsequently via the HDC 110, the CPU 101 analyzes the command, and determines whether the position in the magnetic disk 103 accessed by the command execution is in the storage area corresponding to the encryption key set in the encrypting/decrypting circuit 110b. If the determination result is positive, the CPU 101 places the command to the top of the execution order and executes the command.

As described above, the CPU 101 waits until receiving a command not requiring a change in the encryption key setting, and when such a command is received, prioritizes the execution of the command. In this manner, because as many commands not requiring a change in the encryption key setting as possible are executed before any change in the encryption key setting becomes necessary, the number of times the encryption key reset is performed can be reduced effectively, which reduces the encryption key reset time effectively. As a result, the overall processing time can be reduced to improve the processing performance of the HDD 100 more effectively.

The computer programs executed on the HDD 100 in the above embodiments may be stored in a computer connected via a network such as the Internet so that they can be downloaded therefrom via the network. The computer programs may be provided to the computer as being stored in a computer-readable storage medium, such as a compact disc-read only memory (CD-ROM), a flexible disk (FD), a compact disc recordable (CD-R), and a digital versatile disc (DVD), as a file in an installable or executable format.

In the above embodiments, various information such as the name of a user, a user identification (ID), a password, a character string having a predetermined length granted to the user, ID information recorded on an IC card, and biological information for biometrics using, for example, fingerprints can be used as the personal identification information.

The configuration of the HDD 100 is not limited to the example illustrated in FIG. 1. For example, while the encrypting/decrypting circuit 110b is described above as being provided in the HDC 110, it is not so limited thereto. The encrypting/decrypting circuit 110b may be arranged externally to the HDC 110. Furthermore, the HDD 100 may comprise separately an encrypting circuit that encrypts data and a decrypting circuit that decrypts data.

The CPU 101 may perform the reordering process every time a command is executed, every time a command is received from the host system 200 and stored in the queue buffer 109a, every time a predetermined number of commands are stored in the queue buffer 109a, or once in a predetermined time period.

In the third embodiment, among the queued commands, the execution order of the commands not requiring a change in the encryption key setting during the execution thereof is brought up; however, it is not so limited, and an queued command requiring a change in the encryption key setting less number of times during the execution thereof may be placed in a higher execution order.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk device comprising:
a receiver configured to receive a command from an information processor, the command instructing to write data to a recording medium, or to read data from the recording medium, the recording medium being segmented into a plurality of storage areas, each corresponding to an encryption key generated from identification information associated with a user and causing an access to at least one of the storage areas;
an encrypting-and-decrypting module configured to encrypt the data in response to the command instructing to write or to decrypt the encrypted data in response to the command instructing to read using the encryption key;
a read-and-write controller configured to control writing the encrypted data to the recording medium and reading data from the recording medium;
a setting module configured to set the encryption key corresponding to the storage area accessed by the command to the encrypting-and-decrypting module according to execution of the command;
an order controller configured to control an order of executions and to prioritize the command causing an access to the storage area corresponding to the encryption key among the commands yet to be executed; and
an executing module configured to execute the commands in the execution order.

2. The magnetic disk device of claim 1, wherein the order controller is configured to detect an encryption key that is expected to be set to the encrypting-and-decrypting module upon completion of execution of a currently executed command, and to prioritize a command that causes an access to a storage area corresponding to the encryption key detected among the commands yet to be executed.

3. The magnetic disk device of claim 1, wherein the order controller is configured to prioritize the command that does not cause a change in encryption key setting while executed among the commands yet to be executed.

4. The magnetic disk device of claim 1, wherein the order controller is configured to detect an encryption key that is expected to be set to the encrypting-and-decrypting module upon completion of execution of the currently executed command, and to prioritize a command that causes an access to a storage area corresponding to the encryption key detected and causes changes in encryption key setting while executed among the commands yet to be executed.

5. The magnetic disk device of claim 1, further comprising a dividing module configured to divide a command, which is yet to be executed and causes different encryption keys to be set while executed, for the different encryption keys.

6. The magnetic disk device of claim 1, wherein, the order controller is configured to wait until a command causing an access to the storage area is received from the information processor and, upon receiving the command, to assign a first order of execution to the command, when a command which causes an access to the storage area corresponding to the encryption key is not set to the encrypting-and-decrypting module.

7. A command execution method for a magnetic disk device comprising:
receiving a command from an information processor, the command instructing to write data to a recording medium or to read data from the recording medium, the recording medium being segmented into a plurality of storage areas each corresponding to an encryption key generated from identification information associated with a user and causing an access to at least one of the storage areas;
encrypting the data in response to the command to write or decrypting the encrypted data in response to the command to read using the encryption key;
controlling writing the data encrypted by an encrypting-and-decrypting module to the recording medium and reading data from the recording medium;
setting the encryption key corresponding to the storage area accessed by the command to the encrypting-and-decrypting module according to execution of the command;
an order controller controlling an order of executions and to prioritize the command causing an access to the storage area corresponding to the encryption key among the commands yet to be executed; and
an executing module executing the commands in the execution order.

8. The command execution method of claim 7, further comprising detecting an encryption key that is expected to be set to the encrypting-and-decrypting module upon completion of execution of a currently executed command, and prioritizing a command that causes an access to a storage area corresponding to the encryption key detected among the commands yet to be executed.

9. The command execution method of claim 7, further comprising prioritizing the command that does not cause a change in encryption key setting while executed among the commands yet to be executed.

10. The command execution method of claim 7, further comprising detecting an encryption key that is expected to be set to the encrypting-and-decrypting module upon completion of execution of the currently executed command, and prioritizing a command that causes an access to a storage area corresponding to the encryption key detected and causes a substantially small number of changes in encryption key setting while executed among the commands yet to be executed.

11. The command execution method of claim 7, further comprising dividing a command, which is yet to be executed and causes different encryption keys to be set while executed, for the different encryption keys.

12. The command execution method of claim 7, further comprising, waiting until a command causing an access to the storage area is received from the information processor and, upon receiving the command, assigning a first order of execution to the command, when a command which causes an access to the storage area corresponding to the encryption key is not set to the encrypting-and-decrypting module.
